(19) United States
(12) Patent Application Publication
(10) Pub. No.: US 2019/0162382 A1
(43) Pub. Date: May 30, 2019

(54) LAMP FOR VEHICLE

(71) Applicant: SL Corporation, Daegu (KR)

(72) Inventors: Da Il Kang, Gyeongsan (KR); Hyo Jin Han, Gyeongsan (KR)

(73) Assignee: SL Corporation

(21) Appl. No.: 16/159,961

(22) Filed: Oct. 15, 2018

(30) Foreign Application Priority Data
Nov. 30, 2017 (KR) 10-2017-0163384

(51) Int. Cl. F21S 41/68; F21S 43/13; F21S 41/25; F21S 41/40

(52) U.S. Cl. CPC F21S 41/68; F21S 43/13; F21W 2107/10; F21S 41/40; F21S 41/25

(57) ABSTRACT

A lamp for a vehicle is provided. The lamp includes at least one light source which emits light, a first optical element disposed in front of the light source and including a first incident surface on which the light from the light source is incident and a first exit surface from which the light incident from the first incident surface exits, a second optical element disposed in front of the first optical element and including a second incident surface on which the light exiting from the first optical element is incident and a second exit surface from which the light incident on the second incident surface exits, and a light transmission portion disposed between the first and the second optical elements. The first and the second optical elements have a first refractive index, and the light transmission portion has a second refractive index different from the first refractive index.

### CROSS-REFERENCE TO RELATED APPLICATION

This application claims priority from Korean Patent Application No. 10-2017-0163384 filed on Nov. 30, 2017, the disclosure of which is incorporated herein by reference in its entirety.

### BACKGROUND

### 1. Field of the Disclosure

The present disclosure relates to a lamp for a vehicle, and more particularly, to a lamp for a vehicle which is capable of forming a differentiated lamp image and a beam pattern simultaneously.

### 2. Description of the Related Art

Generally, a vehicle includes a variety of lamps which have an illumination function for more easily recognizing an object disposed around the vehicle during low light conditions (e.g., night time) or a signaling function for informing other vehicles around the vehicle or road users of a driving state of the vehicle. For example, there are a headlamp and a fog lamp generally used for the illumination function, and a turn signal lamp, a tail lamp, a brake lamp, and a side marker and the like used for the signaling function. Installation criteria and specifications of these lamps for a vehicle are defined by regulations to perform all functions thereof.

Among lamps for a vehicle, a headlamp, which forms a low beam pattern or a high beam pattern to ensure a front field of vision for a driver during nighttime driving, performs an important function for driving safely. A headlamp generally forms a low beam pattern to prevent a driver of a vehicle in an opposite lane or a driver of a preceding vehicle from being blinded and forms a high beam pattern as necessary when operating at a high speed or through a place with low ambient brightness to promote safe driving.

Tail lamps are rear lamps mounted on a rear side of a vehicle and include a tail-brake lamp, a turn signal lamp, a backup lamp, and the like. Among them, the tail-brake lamp performs as a taillight which informs a following vehicle a position of the own vehicle during nighttime driving and a stop light which informs the following vehicle of a speed reduction of the own vehicle. Further, a turn signal lamp allows a vehicle around to recognize a change in a traveling direction of an own vehicle by blinking when a driver operates a direction indicating lever. Also, a backup lamp performs as a reversing light which indicates a backward movement of a vehicle by illuminating when a reverse gear is selected.

In such conventional lamps for a vehicle, merely an illumination function or a signaling function is performed since the lighting is formed by an amount of light which exits from a light source and is transmitted outward.

Therefore, a lamp for a vehicle capable of improving a lighting image beyond a simple illumination function or a signaling function and providing aesthetics to increase quality of the product is required.

### SUMMARY

Aspects of the present disclosure provide a lamp for a vehicle, capable of efficiently forming a differentiated lighting image and a beam pattern simultaneously when light generated by a light source is transmitted through a lens.

It should be noted that objects of the present disclosure are not limited to the above-described objects, and other objects of the present disclosure will be apparent to those skilled in the art from the following descriptions.

According to aspects of the present disclosure, a lamp for a vehicle may include at least one light source which emits light, a first optical element disposed in front of the light source and including a first incident surface on which the light from the light source is incident and a first exit surface from which the light incident from the first incident surface exits, a second optical element disposed in front of the first optical element and including a second incident surface on which the light exiting from the first optical element is incident and a second exit surface from which the light incident on the second incident surface exits, and a light transmission portion disposed between the first optical element and the second optical element. In particular, the first optical element and the second optical element may have a first refractive index, and the light transmission portion may have a second refractive index different from the first refractive index.

Details of other examples are included in a detailed description and drawings.

### BRIEF DESCRIPTION OF THE DRAWINGS

The above and other aspects and features of the present disclosure will become more apparent by describing in detail exemplary embodiments thereof with reference to the attached drawings, in which:

FIGS. 1 and 2 are views of a lamp for a vehicle according to some exemplary embodiments of the present disclosure;

FIG. 3 is a view schematically illustrating a first optical element and a second optical element of the lamp according to some exemplary embodiments of the present disclosure;

FIG. 4 is a view illustrating a beam pattern of the lamp according to some exemplary embodiments of the present disclosure;

FIGS. 5A to 5D are views illustrating a first pattern of the first optical element and a second pattern of the second optical element of the lamp according to some exemplary embodiments of the present disclosure;

FIG. 6 is a view illustrating a plurality of the first optical elements and a plurality of the second optical elements of the lamp according to some exemplary embodiments of the present disclosure;

FIGS. 7 and 8 are views of a lamp for a vehicle according to other exemplary embodiments of the present disclosure;

FIG. 9 is a view schematically illustrating a first optical element and a second optical element of the lamp according to other exemplary embodiments of the present disclosure; and

FIGS. 10A and 10B are views illustrating a beam pattern of the lamp according to other exemplary embodiments of the present disclosure.

### DETAILED DESCRIPTION

Hereinafter, exemplary embodiments of the present disclosure will be described in detail with reference to the attached drawings. Advantages and features of the present disclosure and a method of achieving the same will become apparent with reference to the attached drawings and exemplary embodiments described below in detail. However, the present disclosure is not limited to the exemplary embodiments described below and may be embodied with a variety of different modifications. The exemplary embodiments are merely provided to allow one of ordinary skill in the art to understand the scope of the present disclosure and are defined by the scope of the claims. Throughout the specification, like reference numerals refer to like elements.

Unless defined otherwise, all the terms (including technical and scientific terms) used in the specification may be used as meanings understood in common by one of ordinary skill in the art. Also, terms such as those defined in commonly used dictionaries should not be interpreted in an idealized or excessively formal sense unless defined otherwise.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

A lamp for a vehicle according to some exemplary embodiments of the present disclosure may be used for a headlamp installed on each of both front sides of a vehicle to provide a view in front of the vehicle by emitting light in a traveling direction when the vehicle operates in a dark place or may be used for a variety of types of lamps installed in a vehicle such as a tail lamp, a brake lamp, a fog lamp, a position lamp, a turn-signal lamp, a daytime running light, a backup lamp, and the like.

Hereinafter, some exemplary embodiments of the present disclosure will be described in detail with reference to the attached example drawings.

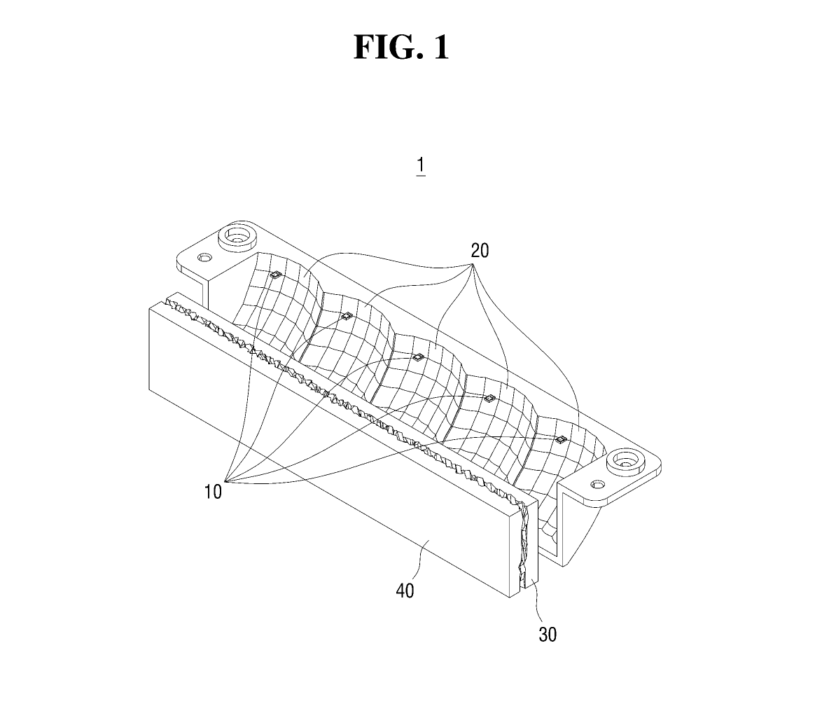

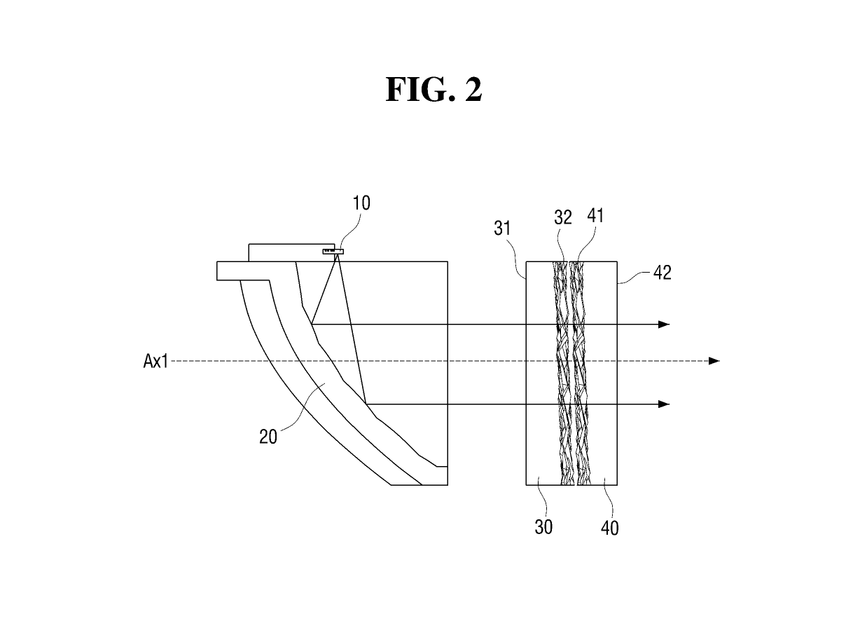

FIGS. 1 and 2 are views of a lamp 1 for a vehicle according to some exemplary embodiments of the present disclosure. Referring to FIG. 1, the lamp 1 according to some exemplary embodiments of the present disclosure may include at least one light source 10, at least one first optical element 30, and at least one second optical element 40. The at least one light source 10 may produce light having an amount and color for a use of the lamp 1 according to some exemplary embodiments of the present disclosure. The light source 10 may generate light and may be formed as a light emitting diode (LED) semiconductor light emitting device but is not limited thereto, and a laser diode (LD) and a bulb type lamp may be used as a light source. Examples of the bulb type lamp may include a halogen lamp, a high intensity discharge (HID) lamp, and the like. Also, a plurality of such light sources 10 may be included to satisfy a required light amount, and arrangement of the plurality of light sources may vary.

Further, according to some exemplary embodiments of the present disclosure, forward reflection or exit of light refers to transmission of light in a direction in which light is emitted from the lamp according to some exemplary embodiments of the present disclosure, and a direction of “forward” may vary based on a position, direction, or the like of the lamp according to some exemplary embodiments of the present disclosure is installed.

The at least one first optical element 30 may be disposed in front of the light source 10, and may include a first incident surface 31 on which light generated by the light source 10 is incident and a first exit surface 32 from which the light incident on the first incident surface 31 exits. The at least one second optical element 40 may be disposed apart from the first optical element 30 to a forward direction, and may include a second incident surface 41 on which at least some light which exits from the first exit surface 32 is incident and a second exit surface 42 from which the light incident from the second incident surface 41 exits. Accordingly, a light transmission portion 50 may be disposed between the first optical element 30 and the second optical element 40.

Particularly, the first optical element 30 and the second optical element 40 may be formed to have a first refractive index and the light transmission portion 50 may be formed to have a second refractive index different from the first refractive index. The refractive indexes may vary based on a medium of each component, and since the light transmission portion 50 may be formed of air, the second refractive index may be about 1.

At least some light, which exits from the first optical element 30, may be incident on the second incident surface 41 of the second optical element 40 and may exit as a parallel light from the second exit surface 42 to form a predetermined beam pattern. In particular, the predetermined beam pattern may be one of patterns formed by a low beam, a high beam, a turn signal, a position, daytime running lights (DRL), and the like. Also, since the first exit surface 32 of the first optical element 30 may include a first pattern obtained by processing at least a part of an area thereof and the second incident surface 41 may include a second pattern obtained by processing at least a part of an area thereof, at least some light that exits from the first optical element 30 may be totally reflected by at least one of the first pattern or the second pattern in the light transmission portion 50 or may be incident again on the second incident surface 41 and exit from the second exit surface 42 to form a lighting image, which will be described below in detail. Accordingly, the lamp 1 according to some exemplary embodiments of the present disclosure may simultaneously form a lighting image differentiated from a conventional lamp and a particular beam pattern.

For example, in the case of a general fisheye lens, although a particular beam pattern may be formed by light which passes through the lens, a lighting image such as the one from the lamp 1 according to some exemplary embodiments of the present disclosure is unable to be formed when lit. As another example, in the case of a lens with a jewelry-like image embodied on one surface, although a slightly differentiated lighting image may be embodied by reflecting light, a predetermined beam pattern such as the one from the lamp 1 according to some exemplary embodiments of the present disclosure is more difficult to form.

Furthermore, the first optical element 30 and the second optical element 40 may be formed from one lens. Accordingly, the first pattern and the second pattern may be formed by cutting one lens in a direction perpendicular to an optical axis Ax1 of the first optical element by using various methods.

Also, the lamp 1 according to some exemplary embodiments of the present disclosure may further include at least one reflector. The number of the reflector 20 may vary according to the number of the light sources 10. In some exemplary embodiments of the present disclosure, the at least one reflector 20 may reflect the light generated by the light source 10 substantially forward.

As shown in FIGS. 1 and 2, the reflector 20 may have a surface which is open from a top toward a front to reflect the light generated downward from the light source 10 substantially forward, but is not limited thereto. When light is generated upward from the light source 10, the reflector 20 may have a surface which is open from a bottom toward the front to reflect the light forward. Accordingly, at least one of light generated by the light source 10 or light reflected by the reflector 20 may be incident on the first incident surface 31 of the first optical element 30.

Hereinafter, the first optical element 30 and the second optical element 40 of the lamp 1 according to some exemplary embodiments of the present disclosure will be described as follows.

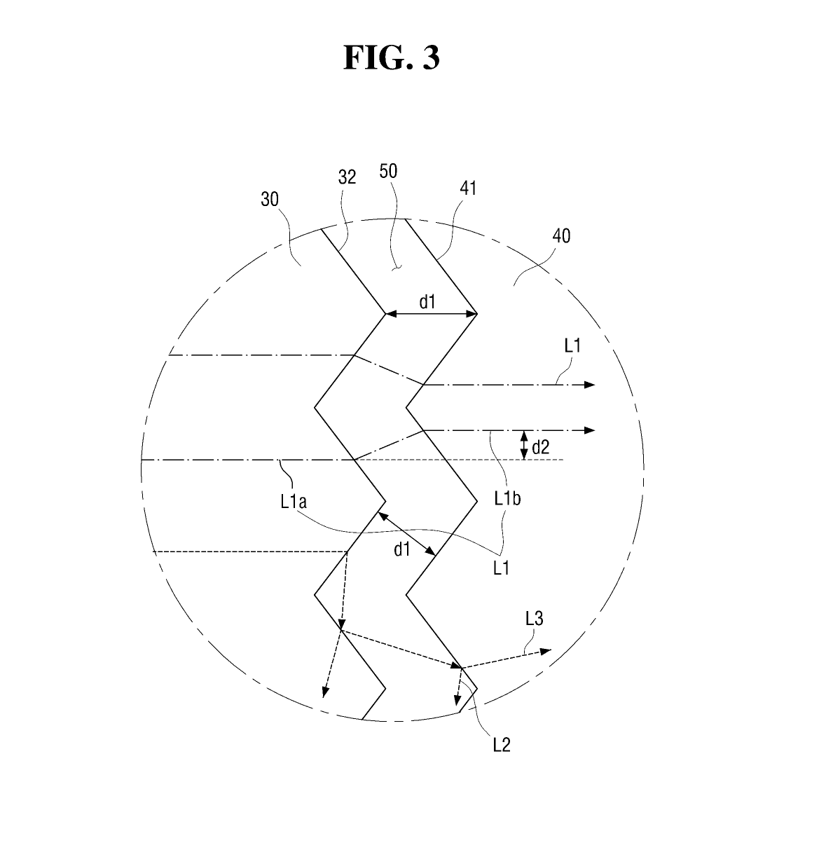

FIG. 3 is a view illustrating the first optical element 30 and the second optical element 40 according to some exemplary embodiments of the present disclosure. Referring to FIG. 3, at least some light emitted by the light source of the lamp 1 according to some exemplary embodiments of the present disclosure may form a first light beam L1 which is incident on the first incident surface 31, passes through the light transmission portion 50, and exits from the first exit surface 32. The first light beam L1 may exit as parallel light from the second exit surface 42 and may form a predetermined beam pattern.

Although the light transmission portion 50 is formed to allow the first optical element 30 and the second optical element 40 to be spaced apart, since a traveling direction of light is unchanged, a particular beam pattern may be formed. Generally, when light is incident on a lens, the incident light may be refracted by the lens and exits. For example, since an angle of light between a path of the light that is incident on the lens and an optical axis of the lens may be equal to an angle of light between a path of the light that exits from the lens and the optical axis of the lens, the overall path of the light may be unchanged.

Accordingly, since a traveling direction, in which the first light beam L1 of the lamp 1 according to some exemplary embodiments of the present disclosure is incident on and exits from the first optical element 30, proceeds toward a front of the optical axis Ax1 of the first optical element 30 and a traveling direction, in which the first light beam L1 is incident on and exits from the second optical element 40 again, also faces the front of the optical axis Ax1 of the first optical element 30, even when the light passes through the first optical element 30 and the second optical element 40 spaced apart from the first optical element 30, the traveling direction thereof may be unchanged to form a beam pattern similar to the beam pattern formed by the at least one reflector 20. Also, a path of the first light beam L1, which passes through the first optical element and the second optical element, may be uninfluenced by the first pattern of the first exit surface 32 and the second pattern of the second incident surface 41.

As described above, since the light transmission portion 50 is formed between the first optical element 30 and the second optical element 40, a perpendicular distance between a point of the first exit surface 32 and the second incident surface 41 may have a preset first distance d1 and the first distance d1, which is a perpendicular distance between each of all points on the first exit surface 32 and the second incident surface 41 may be constant. It will be described below in detail.

Further, the first light beam L1 may include a first path L1a, which passes through the first optical element, and a second path L1b which passes through the second optical element. The first path L1a and the second path L1b may be formed to be parallel to each other and be spaced apart by a second distance d2 in a direction perpendicular to the first path L1a. In particular, the second distance d2 may be proportional to the first distance d1. Accordingly, since the second distance d2 increases as a width of the light transmission portion 50 increases, the path of the first light beam L1 may vary based on the width of the light transmission portion 50.

At least some of light emitted by the light source of the lamp 1 according to some exemplary embodiments of the present disclosure may be incident on the first incident surface 31 of the first optical element 30 and may exit from the first exit surface 32, and a first portion of the light, which exits from the first exit surface 32, may form a second light beam L2 and a second portion of the light may form a third light beam L3.

The second light beam L2 may be totally reflected within the light transmission portion 50 by the first exit surface 32 and the second incident surface 41, and the third light beam L3 may be incident again on the second incident surface 41 of the second optical element 40 and exit from the second exit surface 42 to form a lighting image. In other words, the light may be separated into the second light beam L2 and the third light beam L3. Accordingly, as described above, some light, which exits from the first exit surface 32, may be separated in the light transmission portion 50, which splits light, by the first exit surface 32 and the second incident surface 41.

Also, when the second light beam L2 and the third light beam L3 are totally reflected by the first exit surface 32 and the second incident surface 41 or incident on the second incident surface 41, reflection directions and angles may differ from incident directions and angles depending on dimensions and geometry of the first pattern of the first exit surface 31 and the second pattern of the second incident surface 41. Therefore, since the second light beam L2 and the third light beam L3 are totally reflected in various directions or incident on the second incident surface 41 by the first pattern of the first optical element 30 and the second pattern of the second optical element 40 as shown in FIG. 3, flickering (e.g., glittering, sparkling or twinkling) may occur depending on a viewing angle by a driver or a pedestrian who observes the lamp 1 according to some exemplary embodiments of the present disclosure or a particular sensation may be provided to a driver or a pedestrian depending on an observation angle such that aesthetics of the lamp may increase.

Since a proportion of the first light beam is greater than those of the second light beam and the third light beam among a total light amount generated by the lamp 1 according to some exemplary embodiments of the present disclosure, a particular beam pattern may be formed more effectively. For example, the first light beam L1 may correspond to about 70% of the total light amount and the second light beam L2 and the third light beam L3 may correspond to about the remaining 30%.

As described above, a perpendicular distance between a point of the first exit surface 32 of the first optical element 30 and the second incident surface 41 of the second optical element 40 may have a preset first distance and may be set to about 3 mm or less. In particular, a direction of the perpendicular distance may be formed to be toward an optical axis Ax of a light source portion but is not limited thereto.

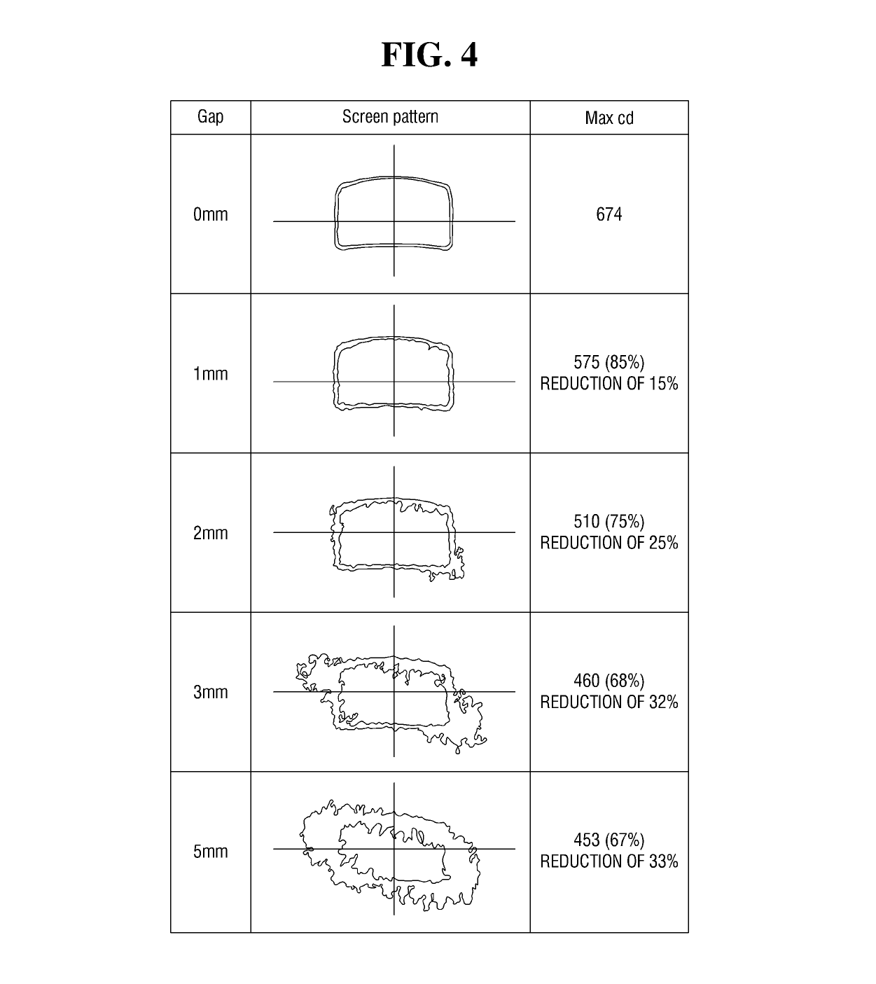

FIG. 4 is a view illustrating a beam pattern of the lamp according to some exemplary embodiments of the present disclosure. The table shows a gap value that indicates a first distance d1, a screen pattern depending on a beam pattern formed by the first light beam L1, and light intensity depending on the beam pattern. Referring to FIG. 4, a particular beam pattern may be formed when the first distance is 0 mm, in other words, when the first optical element 30 and the second optical element 40 according to some exemplary embodiments of the present disclosure are formed as a single lens. Also, when the first distance d1 is 1 mm, 2 mm, or 3 mm, although light intensity decreases, a particular beam pattern may be formed by the first light beam L1 similar to the case in which the first distance is 0 mm. Accordingly, when the first optical element 30 and the second optical element 40 are spaced apart depending on the light transmission portion 50, a beam pattern may be formed similar to a case in which the first optical element 30 and the second optical element 40 are formed as one lens.

However, when the first distance d1 is more than about 3 mm, although the light, which exits from the first optical element 30, is incident on the second optical element 40, an effective beam pattern may be unable to be formed due to the distance. As described above, since the second distance is proportional to the first distance d1, the second path L2b of the first light beam L1 may be changed as the first distance d1 increases to make it more difficult to form a particular beam pattern.

Furthermore, as described above, the first exit surface 32 of the first optical element 30 may include the first pattern and the second incident surface 41 of the second optical element 40 may include the second pattern. The first pattern and the second pattern may be formed corresponding to each other or may be formed to differ from each other. When the first pattern and the second are formed corresponding to each other, the first exit surface 32 and the second incident surface 41 may be formed with the first distance d1 therebetween as described above.

For example, as shown in FIG. 3, the first pattern of the first exit surface 32 may be formed to have a shape with a plurality of protrusions toward the light transmission portion 50, and the second pattern of the second incident surface 41 may have a shape with a plurality of recesses toward an inside of the second optical element 40 that correspond to the first pattern. Particularly, since the first pattern and the second pattern are formed corresponding to each other, a distance between a point of the first exit surface 32 and a point of the second incident surface 41 disposed perpendicular thereto may be formed equally. In other words, the first pattern and the second pattern may be formed with a uniform (e.g., constant) distance therebetween.

When the first pattern and the second pattern are formed to differ from each other, the first exit surface 32 and the second incident surface 41 may have a plurality of distances therebetween within a range of about 3 mm or less. A distance between the first pattern and the second pattern may not be uniform. Accordingly, perpendicular distances between at least some points of the first exit surface 32 and the second incident surface 41 may be formed to differ from one another.

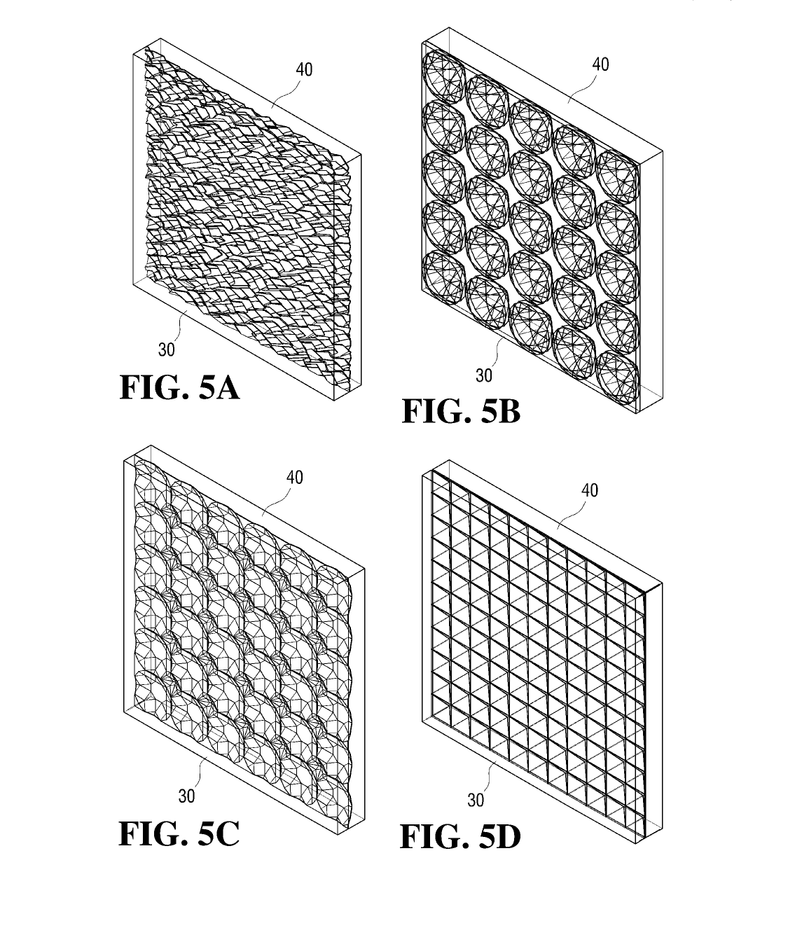

Referring to FIGS. 5A and 5B, the first pattern of the first optical element 30 and the second pattern of the second optical element 40 according to some exemplary embodiments of the present disclosure may have various shapes. As shown in FIG. 5A, the first pattern and the second pattern may be formed of a plurality of optics which have different sizes and include particles. As shown in FIG. 5B, one of the first pattern and the second pattern may be formed to have a shape with a plurality of diamonds that protrude toward the light transmission portion 50, and the other may be formed to have a shape with a plurality of recesses toward the inside of the optical element according to the shape of the plurality of protruding diamonds. As shown in FIG. 5C, one of the first pattern and the second pattern may be formed to have a shape with a plurality of protrusions, and the other may be formed to have a shape with a plurality of recesses toward the inside of the corresponding optical element according to the shape of the plurality of protrusions. As shown in FIG. 5D, one of the first pattern and the second pattern may be formed to have a shape with a plurality of polygons that protrude toward the light transmission portion 50, and the other may be formed to have a shape with a plurality of recesses toward the inside of the optical element according to the shape of the plurality of protruding polygons. Also, the first pattern and the second pattern may have a variety of shapes with the first distance d1 maintained therebetween in addition to the shapes shown in FIGS. 5A to 5D.

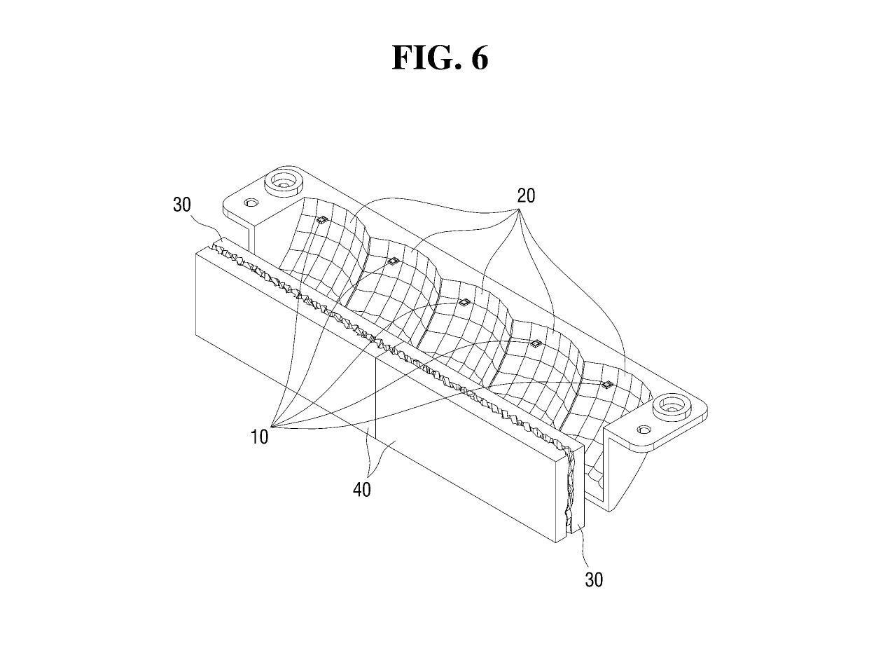

The lamp 1 according to some exemplary embodiments of the present disclosure may include a plurality of such first optical elements and a plurality of such second optical elements. FIG. 6 is a view illustrating a plurality of first optical elements 30 and a plurality of second optical elements 40 of the lamp 1 according to some exemplary embodiments of the present disclosure. Although two first optical elements 30 and two second optical element 40 are shown in FIG. 6, the present disclosure is not limited thereto and shapes and numbers of the first optical elements 30 and the second optical elements 40 may vary based on a dimension and a geometry of a desired beam pattern.

In detail, as described above, the plurality of first optical elements 30 may be disposed in front of at least one light source 10 to allow the light, which is transferred from at least one of the light source 10 and the reflector 20, to be incident thereon, and the plurality of second optical elements 40 may be spaced apart from the plurality of first optical elements 30 in a front direction to allow at least some light, which exits from the first optical elements 30, to be incident thereon.

In particular, the plurality of first optical elements and the plurality of second optical elements may be arranged in a direction perpendicular to the optical axis Ax of the first optical elements. Accordingly, as described above, at least some light, which exits from the second exit surfaces 42 of the plurality of the second optical elements 40 may form a particular beam pattern, and the light, which exits from the first exit surfaces 32 of the first optical elements 30 may be totally reflected in various directions by the first pattern of the plurality of first optical elements 30 and the second pattern of the plurality of second optical elements 40 and separated to be incident on and exit from the second optical elements 40 to form a lighting image.

Hereinafter, a lamp 2 for a vehicle according to other exemplary embodiments of the present disclosure will be described.

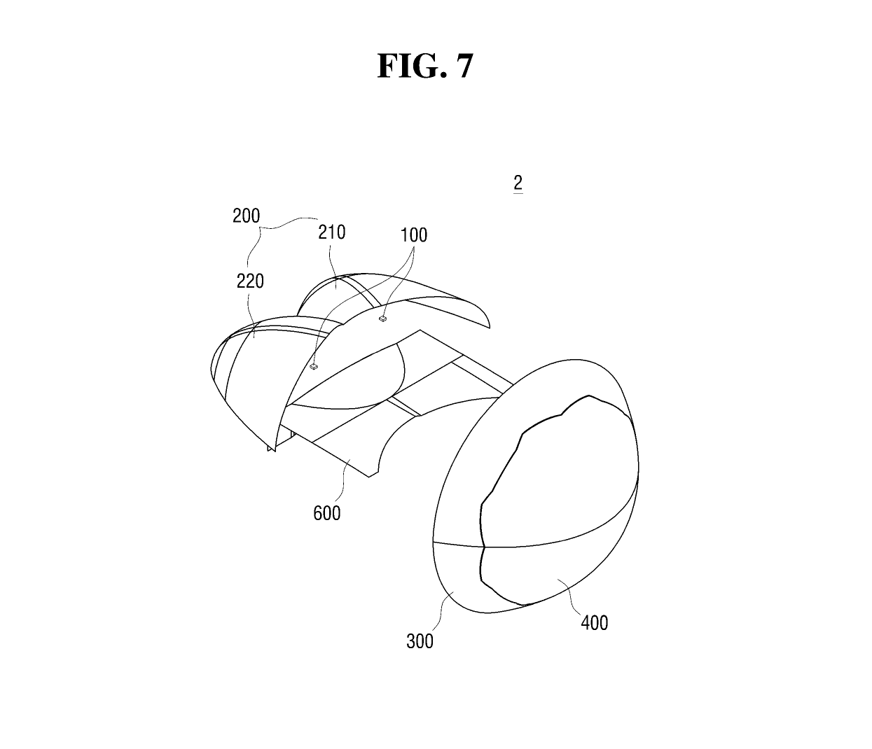

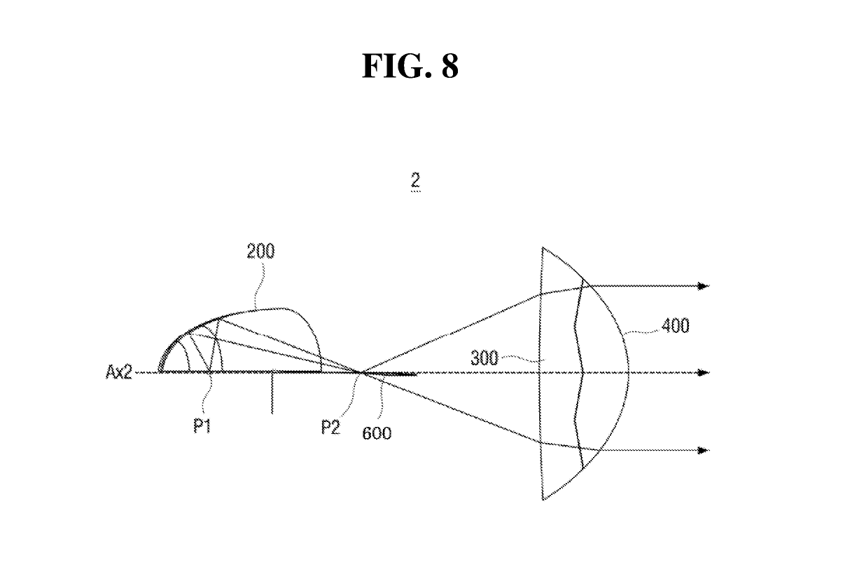

FIGS. 7 and 8 are views of the lamp for a vehicle according to other exemplary embodiments of the present disclosure. Referring to FIGS. 7 and 8, the lamp 2 according to other exemplary embodiments of the present disclosure may include at least one light source 100, at least one reflector 200, a first optical element 300, and a second optical element 400 like the above-described lamp 1. In particular, the first optical element 300 and the second optical element 400 may be formed in one aspheric lens shape when a first exit surface 320 of the first optical element 300 abuts a second incident surface 410 of the second optical element 400. Also, the lamp 2 may further include a shielding portion 600.

The at least one light source 100 may generate light as the above-described light source 10 and may be disposed on or adjacent to an optical axis Ax2 of the first optical element 300. The at least one reflector 200 may reflect the light generated by the light source 100 toward the first optical element 300. The reflector 200 may be disposed above the light source 100 and may have a shape of an oval-curved surface, a parabola-curved surface, or a free-curved surface which has an open front to reflect the light emitted by the light source 100.

The light source may be disposed on a first focal point P1, and the shielding portion 600 may be disposed on a second focal point P2. Also, a plurality of reflectors 200 may be provided and include a first reflector 210 and a second reflector 220 but is not limited thereto. One, three or more reflectors may be included. The first reflector 210 and the second reflector 220 may be arranged to be symmetrical to each other with respect to the optical axis Ax2 of the first optical element 300, but are not limited thereto and may be arranged to be asymmetrical to each other with respect to the optical axis Ax2 of the first optical element 300.

A part of light reflected by the first reflector 210 may form a right side portion of a low beam pattern. Accordingly, the first reflector 210 may have a shape capable of reflecting a part of light, which exits from the light source 100, to be biased rightward. A part of light reflected by the second reflector 220 may form a left side portion of the low beam pattern. Accordingly, the second reflector 220 may have a shape capable of reflecting a part of light, which exits from the light source 100, to be biased leftward.

The shielding portion 600 may be disposed in front of the reflector 200 and the light source 100 and may block a part of the light, which is reflected by the reflector 200 and proceeds toward the first optical element 300 to form a low beam pattern emitted below a cut-off line. In other words, the shielding portion 600 may block a part of the light, which is reflected by the at least one reflector 200 and proceeds toward the first optical element 300, and may pass the light that corresponds to the low beam pattern, and thereby form the cut-off line. Accordingly, a cut-off edge that corresponds to the cut-off line may be formed on a front end of the shielding portion 600.

Also, the shielding portion 600 may include a reflecting surface for reflecting light reflected by the at least one reflector 200 toward the first optical element 300. The first optical element 300 may be disposed in front of the shielding portion 600 and the reflector 200, and the second optical element 400 may be disposed to be spaced apart by a preset first distance from the first optical element 300 in the front direction. In particular, the first distance may be set to about 3 mm or less as described above. Accordingly, as described above, a light transmission portion 500 may be formed between the first optical element 300 and the second optical element 400.

Also, as shown in FIG. 7, since the first optical element 300 and the second optical element 400 may be formed in one aspheric lens shape when the first exit surface 320 of the first optical element 300 abuts the second incident surface 410 of the second optical element 400, an exit surface of the second optical element 400 may be formed to convexly protrude forward but is not limited thereto. Accordingly, as shown in FIG. 8, at least some light generated by the at least one light source 100 may be reflected by the reflector 200, pass through the second focal point P2, and be incident on a lower area of the first optical element 300 disposed below the optical axis Ax2 of the first optical element 300, and other light generated by the light source 100 may be reflected by the reflector 200, be reflected again by the shielding portion 600, and be incident on an upper area of the first optical element 300 disposed above the optical axis Ax2 of the first optical element 300.

At least some light, which exits from the first optical element 300, may be incident on the second incident surface 410 of the second optical element 400 and may exit from the second exit surface 420 to form a predetermined beam pattern. The first exit surface 320 of the first optical element 300 may include a first pattern, and the second incident surface 410 may include a second pattern. Accordingly, similar to the lamp 1, the light, which exits from the first exit surface 320 of the first optical element 300 may be formed to be totally reflected in various directions within the light transmission portion 500 by at least one of the first pattern and the second pattern. A part thereof may be incident again on the second incident surface 410 and exit from the second exit surface 420 to form a lighting image. Accordingly, the lamp 2 according to other exemplary embodiments of the present disclosure may form a differentiated lighting image and a low beam pattern simultaneously like the above-described lamp 1.

Hereinafter, the first optical element 300 and the second optical element 400 of the lamp 2 according to other exemplary embodiments of the present disclosure will be described as follows.

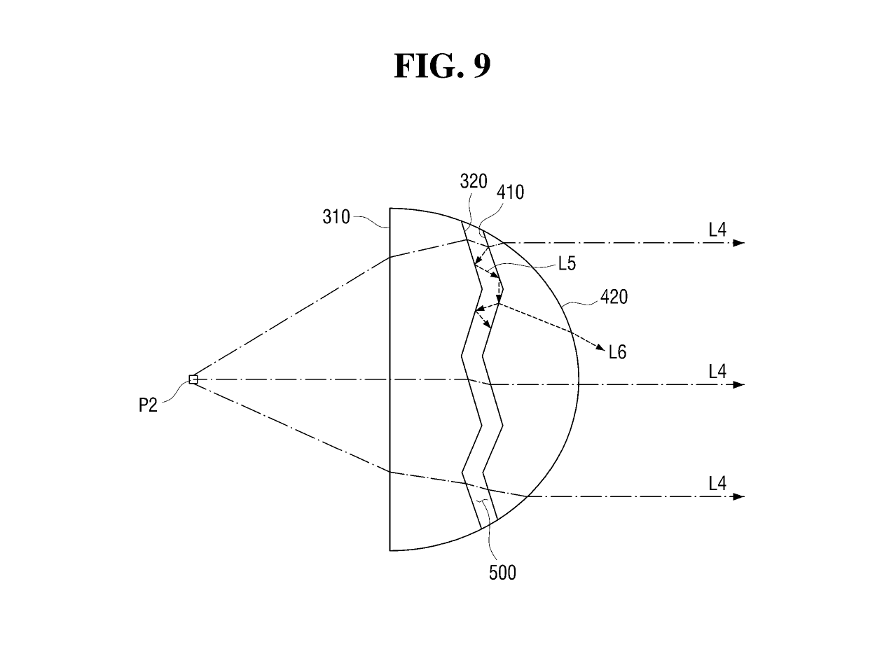

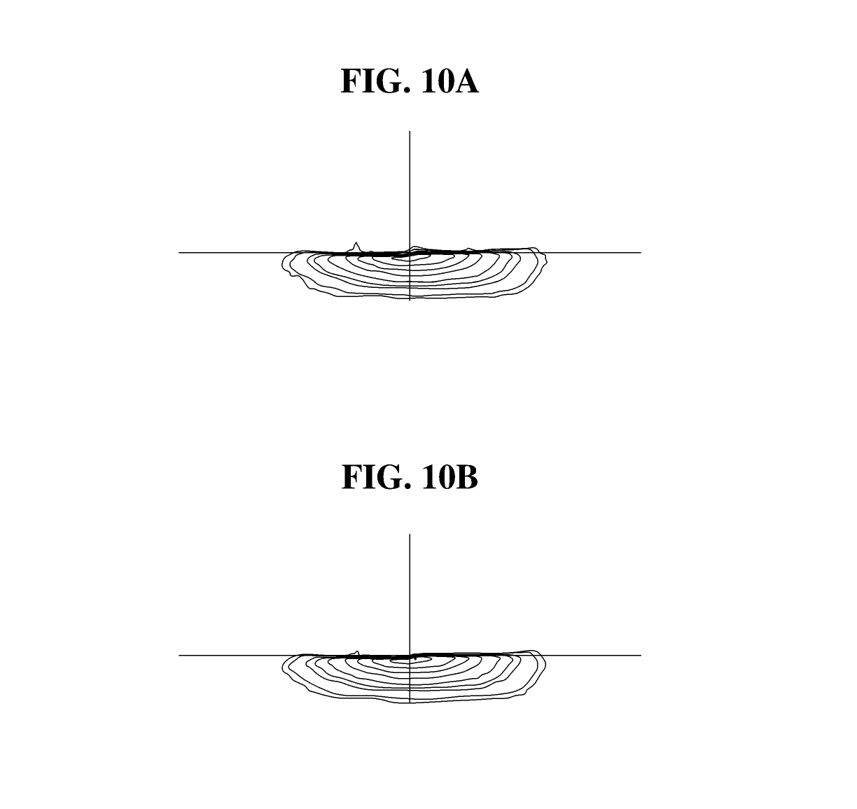

FIG. 9 is a view schematically illustrating the first optical element 300 and the second optical element 400 of the lamp 2 according to other exemplary embodiments of the present disclosure, and FIGS. 10A and 10B are views illustrating a beam pattern of the lamp 2 according to other exemplary embodiments of the present disclosure. Referring to FIGS. 9, 10A, and 10B, a fourth light beam L4 which is at least one beam of light that passes through the second focal point P2 of the lamp 2 according to other exemplary embodiments of the present disclosure and exits from the first optical element 300, may pass through the light transmission portion 500 formed between the first optical element 300 and the second optical element 400, be incident on the second incident surface 410, and exit from the second exit surface 420 to form a low beam pattern shown in FIG. 10A.

FIG. 10B is a view illustrating a low beam pattern formed by one aspheric lens. Comparing FIGS. 10A and 10B with each other, the low beam pattern formed by the first optical element 300 and the second optical element 400 of the lamp 2 according to other exemplary embodiments of the present disclosure and the low beam pattern formed by the one aspheric lens may be similar to each other.

In other words, when light generated by the light source 100 of the lamp 2 according to other exemplary embodiments of the present disclosure is reflected by the reflector 200, passes through the second focal point P2, and is transmitted by the first optical element 300 and the second optical element 400 spaced apart form the first optical element, a proceeding direction of light may be maintained as described above to form a low beam pattern.

Referring back to FIG. 9, since a fourth light beam L4 which is another of beams of light that exits from the first exit surface 320 of the lamp 2 according to other exemplary embodiments of the present disclosure may be reflected toward the first exit surface 320 by the second incident surface 410 and reflected again toward the second incident surface 410 by the first exit surface 320, the fourth light beam L4 may be totally reflected in the light transmission portion 500. Also, a sixth light beam L6, which is a part of a fifth light beam L5 totally reflected by the light transmission portion 500 configured to split light as described above, may be incident again on the second incident surface 410 and exit from the second exit surface 420 to form a lighting image.

In addition, since the first exit surface 320 and the second incident surface 410 may include the first pattern and the second pattern, respectively, as described above, when light is reflected by the first exit surface 320 and the second incident surface 410, a direction and an angle of total reflection may vary according to the first pattern and the second pattern. Therefore, since the light may be totally reflected in various directions and be incident on the second incident surface 410 by the first pattern of the first optical element 300 and the second pattern of the second optical element 400, flickering may occur depending on a direction from which a driver or a pedestrian observes the lamp 2 according to other exemplary embodiments of the present disclosure and a particular sensation may be provided based on an angle at which a driver or a pedestrian observes to form a low beam pattern with increased aesthetics of the lamp. Moreover, the first pattern and the second pattern may have a variety of shapes including the shapes shown in FIGS. 5A to 5D.

According to some exemplary embodiments of the present disclosure, in a lamp for a vehicle, a first optical element and a second optical element may be spaced apart by a preset distance to allow the light, which exits from the first optical element, to be scattered within a space and form a differentiated lighting image and light, which exits from the second optical element, may form a particular beam pattern. Effects of the present disclosure will not be limited to the above-mentioned effects and other unmentioned effects will be clearly understood by those skilled in the art from the following claims.

Although the exemplary embodiments of the present disclosure have been described with reference to the attached drawings, it should be understood by one of ordinary skill in the art that the present disclosure may be implemented in other detailed forms without changing the technical concept or essential features thereof. Therefore, the above-described embodiments should be understood to be exemplary and not limiting in every aspect.

What is claimed is:

1. A lamp for a vehicle, comprising:
at least one light source which emits light;
a first optical element disposed in front of the light source and comprising a first incident surface on which the light from the light source is incident and a first exit surface from which the light incident from the first incident surface exits;
a second optical element disposed in front of the first optical element and comprising a second incident surface on which the light that exits from the first optical element is incident and a second exit surface from which the light incident on the second incident surface exits; and
a light transmission portion disposed between the first optical element and the second optical element,
wherein the first optical element and the second optical element have a first refractive index, and the light transmission portion has a second refractive index different from the first refractive index.

2. The lamp of claim 1, wherein at least a part of the light emitted by the light source forms a first light beam which is incident on the first incident surface, passes through the light transmission portion, and exits from the second exit surface.

3. The lamp of claim 1, wherein at least a part of the light emitted by the light source is incident on the first incident surface and exits from the first exit surface, and
wherein a first portion of the part of the light, which exits from the first exit surface, forms a second light beam, which is totally reflected within the light transmission portion by the first exit surface and/or the second incident surface, and a second portion of the part of the light forms a third light beam which is incident on the second optical element and exits from the second exit surface.

4. The lamp of claim 2, wherein the first light beam exits as a parallel light from the second exit surface and forms a predetermined beam pattern.

5. The lamp of claim 3, wherein the third light beam exits from the second exit surface and forms a lighting image.

6. The lamp of claim 1, wherein the first exit surface includes a first pattern, the second incident surface includes a second pattern, and the first pattern and the second pattern are formed to correspond to each other.

7. The lamp of claim 2, wherein a perpendicular distance between a point on the first exit surface and the second incident surface is a preset first distance, and the first distance is equal for each of points on the first exit surface and the second incident surface.

8. The lamp of claim 7, wherein the first light beam comprises a first path which passes through the first optical element, and a second path which passes through the second optical element, and wherein the first path and the second path are formed to be parallel to each other while being spaced apart by a second distance in a direction perpendicular to the first path.

9. The lamp of claim 8, wherein the second distance is proportional to the first distance.

10. The lamp of claim 7, wherein the first distance is about 3 mm or less.

11. The lamp of claim 1, further comprising a reflector which reflects the light from the light source toward the first optical element.
